(19) United States
(12) Patent Application Publication
(10) Pub. No.: US 2023/0151838 A1
(43) Pub. Date: May 18, 2023

(54) TOOL-FREE TIGHTENING ELEMENT AND CONNECTION FITTING

(71) Applicant: Häfele Berlin GmbH & Co KG, Berlin (DE)

(72) Inventors: Robert Birkner, Berlin (DE); Gerd Sawatzki, Datteln (DE)

(73) Assignee: Häfele Berlin GmbH & Co KG, Berlin (DE)

(21) Appl. No.: 18/056,872

(22) Filed: Nov. 18, 2022

Related U.S. Application Data
(63) Continuation of application No. PCT/EP2021/061077, filed on Apr. 28, 2021.

(30) Foreign Application Priority Data
May 22, 2020 (DE) 20 2020 102 943.6

(51) Int. Cl. F16B 12/20

(52) U.S. Cl. CPC F16B 12/2009; F16B 2012/209

(57) ABSTRACT

A tightening element for the tool-free tightening of a clamping bolt includes a cylindrical pot-shaped housing having a pot opening. At the end side of the housing opposite the pot opening, at least one handle is pivotably supported about an axis which extends at right-angles to the center axis of the housing between a folded-up position which protrudes from the housing and a folded-down end position which rests against the end side.

### CROSS-REFERENCE TO RELATED APPLICATIONS

This continuation application claims priority to PCT/EP2021/061077 filed on Apr. 28, 2021, which has published as WO 2021/233652 A1, and also the German application number 20 2020 102 943.6 filed on May 22, 2020, the entire contents of which are fully incorporated herein with these references.

### DESCRIPTION

### Field of the Invention

The invention relates to a tightening element for the tool-free tightening of a clamping bolt, comprising a cylindrical pot-shaped housing having a pot opening.

### Background of the Invention

Such tightening elements and connection fittings are adequately known and serve to secure two items of furniture which abut each other at an angle, preferably at right-angles. Known tightening elements have a drive for a screwdriver in order to rotate the tightening element which is inserted into a surface hole of an item of furniture and thus to connect the two items of furniture to each other in a gap-free manner.

In this regard, an object of the invention is to further improve a tightening element of the type mentioned in the introduction, in particular to be able to rotate it in a tool-free manner.

### SUMMARY OF THE INVENTION

This object is achieved according to the invention in that, at the end side of the housing opposite the pot opening, at least one handle is pivotably supported about an axis which extends at right-angles to the center axis of the housing between a folded-up position which protrudes from the housing and a folded-down end position which rests against the end side.

According to the invention, the at least one handle forms in the folded-up end position a rotary handle for rotating the tightening element within the surface hole so that a separate tool is not required. After the rotation, the at least one handle can be folded down in order to cover the housing and the surface hole at the end side.

In a first preferred embodiment, at the end side of the housing opposite the pot opening, two handles are pivotably supported about axes which extend at right-angles to the center axis between a folded-up position which protrudes from the housing and a folded-down end position which rests against the end side. In the folded-up end position, the two handles preferably abut each other and thus form a common handle. The two handles are preferably each in the form of semi-circular cover halves which in the folded-down end position together form a circular cover which advantageously completely covers the end side of the housing and which protrudes radially outward over the housing.

In another preferred embodiment, at the end side of the housing opposite the pot opening, a single handle in the form of a in particular semi-circular first cover half is pivotably supported. In the folded-down end position, this handle and a second in particular semi-circular cover half which is fixedly formed at the end side of the housing together form an in particular circular cover. Preferably, the second cover half protrudes radially outward over the housing in order to form a depth stop on the tightening element during insertion into a hole.

In a particularly preferred manner, the at least one handle is locked with the housing in the folded-down end position. In an advantageous development, the at least one handle has a locking projection which in the folded-down end position is engaged in a locking receiving member of the housing, or vice versa. In another advantageous development, the at least one handle has a hook which in the folded-down end position engages in a locking manner behind an undercut of the housing or vice versa.

The pivot axis may, for example, be formed by a pin/hole locking connection between the at least one handle and at least one bearing block of the housing or by a bearing projection/bearing receiving member connection between the foldable and the fixed cover half.

Preferably, the housing has a circumferential wall having a circumferential slot which extends in a circumferential direction, wherein the inner side of the circumferential wall at both sides of the circumferential slot has a tightening contour which is eccentric relative to the center axis of the housing.

The invention further relates to a connection fitting for releasably connecting two items of furniture which abut each other at an angle, preferably at right-angles, preferably items of furniture, comprising a clamping bolt which is intended to be anchored to one item of furniture and comprising a tightening element which is as described above and which is intended to be inserted in a surface hole of the other item of furniture.

The invention finally also relates to a furniture arrangement comprising two items of furniture which abut each other at an angle, preferably at right-angles and which are secured to each other by means of the connection fitting, wherein the clamping bolt is anchored to an end side of one item of furniture and wherein the tightening element is inserted into a surface hole of the other item of furniture and engages behind a bolt head of the clamping bolt. As a result of a rotation of the tightening element, the bolt head of the clamping bolt is gripped and tightened and the two items of furniture are secured to each other in a gap-free manner. After the rotation of the tightening element, the at least one handle is folded down and preferably locked.

Other advantages of the invention will be appreciated from the description, the claims and the drawings. The features which have been mentioned above and those which will be set out below can also be used individually per se or together in any combination. The embodiments shown and described are not intended to be understood to be a definitive listing, but instead are of an exemplary nature to describe the invention.

### BRIEF DESCRIPTION OF THE DRAWINGS

In the drawings:

FIGS. 1a-1c show the tightening element according to the invention having two foldable (rotary) handles, wherein in FIG. 1a both handles are folded up, in FIG. 1b one handle is folded up and the other handle is folded down and in FIG. 1c both handles are folded down;

FIG. 2 shows the individual components of the tightening element according to the invention;

FIGS. 3a, 3b show a modification of the tightening element according to the invention in the folded-up end position (FIG. 3a) and in a detailed view of the handle (FIG. 3b);

FIGS. 4a-4f show the assembly sequence when two furniture panels are connected using the tightening element shown in FIGS. 1 to 3;

FIGS. 5a, 5b show another modification of the tightening element according to the invention with a single foldable (rotary) handle which is shown in FIG. 5a in the folded-up end position and in FIG. 5b in the folded-down end position;

FIG. 6 shows the individual components of the tightening element according to the invention of FIG. 5; and

FIGS. 7a-7d show the assembly sequence when two furniture panels are connected using the tightening element shown in FIG. 5.

### DETAILED DESCRIPTION OF THE PREFERRED EMBODIMENTS

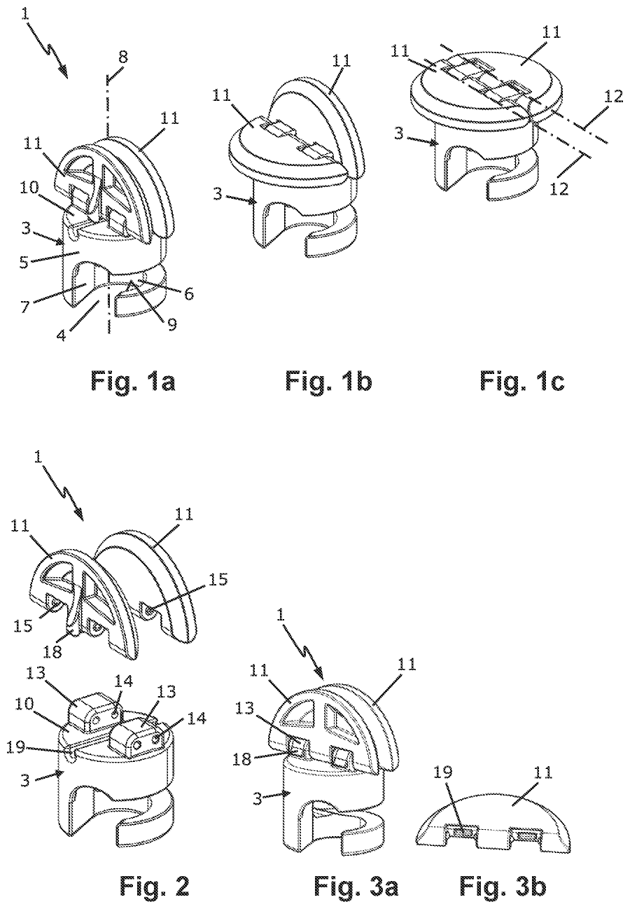

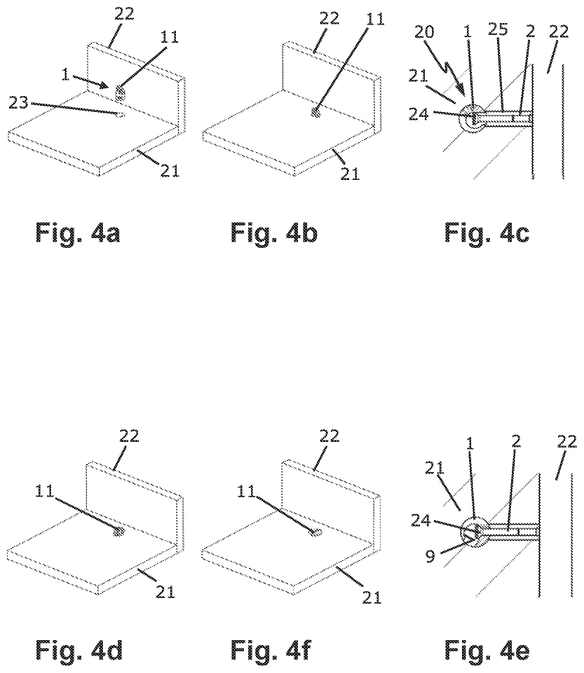

The tightening element 1 shown in FIGS. 1a-1c serves to tighten a clamping bolt 2 (FIGS. 4c, 4e) in a tool-free manner.

The tightening element 1 has a cylindrical, pot-like housing 3 having a pot opening 4 which is open in a downward direction in this instance and having a circumferential wall 5 in which a circumferential slot 6 extends in a circumferential direction. At a slot end, the circumferential slot 6 opens into a recess 7, which is open in a downward direction, of the circumferential wall. The inner side of the circumferential wall 5 has at both sides of the circumferential slot 6 a tightening contour 9 which is eccentric with respect to the center axis 8 of the housing 3.

At the end side 10 of the housing 3 opposite the pot opening 4, two plate-like (rotary) handles 11 are pivotably supported about parallel axes 12 which extend at right-angles with respect to the center axis 8 between a folded-up end position (FIG. 1a) which protrudes from the housing 3 and a folded-down end position (FIG. 1c) which rests against the end side 10. In the folded-up end position, the two handles 11 abut each other and thus form a common handle. The two handles 11 are each in the form of semi-circular cover halves which in the folded-down end position together form a circular cover which completely covers the end side 10 of the housing 3 and which protrudes radially outward over the housing 3.

Preferably, the housing 3 is made from metal, for example, die-cast zinc and the handles 11 are made from plastics material.

As shown in FIG. 2, the end side 10 has two bearing blocks 13 each having locking holes 14 at both sides in which the two handles are engaged with locking pins 15. The locking holes and pins 14, 15 also define the pivot axes 12 of the handles 11. On both handles 11, there is formed in each case at the lower side a locking projection 18 which in the folded-down end position is engaged in a locking receiving member 19 in the end side 10 in order to thus lock the two handles 11 with the housing 3 in the folded-down end position.

The tightening element 1 forms together with the clamping bolt 2 a connection fitting 20 shown in FIG. 4c.

The tightening element 1 shown in FIGS. 3a, 3b differs from the tightening element of FIGS. 1 and 2 only in that in this instance the two bearing blocks 13 in each case have one locking projection 18 and the two handles 11 in each case have two locking receiving members 19. In the folded-down end position, the locking projections 18 are engaged in the locking receiving members 19 in order to thus lock the two handles 11 with the housing 3 in the folded-down end position.

FIGS. 4a to 4f show the assembly sequence when connecting two furniture panels 21, 22 which are in abutment with other at an angle, in this instance at right-angles, using the tightening element 1.

The tightening element 1 is inserted in a surface hole 23 of one, first furniture panel 21 (FIGS. 4a, 4b), wherein the two handles 11 are located in each case in the folded-up end position. There is anchored in the other furniture panel 22 the clamping bolt 2 which extends with the bolt head 24 through a hole 25 in the end side of the first furniture panel 21 and through the open recess 7 of the tightening element 1 as far as a location inside the tightening element 1 (FIG. 4c). Subsequently, the tightening element 1 is rotated in the surface hole 23 using the two folded-up handles 11, that is to say, in a tool-free manner, through, for example, 240° (FIG. 4d). The clamping bolt 2 is thereby introduced into the circumferential slot 6 and the bolt head 24 behind which the tightening contour engages is now tightened further until the two items of furniture 21, 22 abut each other in a gap-free manner (FIG. 4e). Finally, the two handles 11 are folded down and locked in order to cover the surface hole 23 and the housing 3 (FIG. 4f).

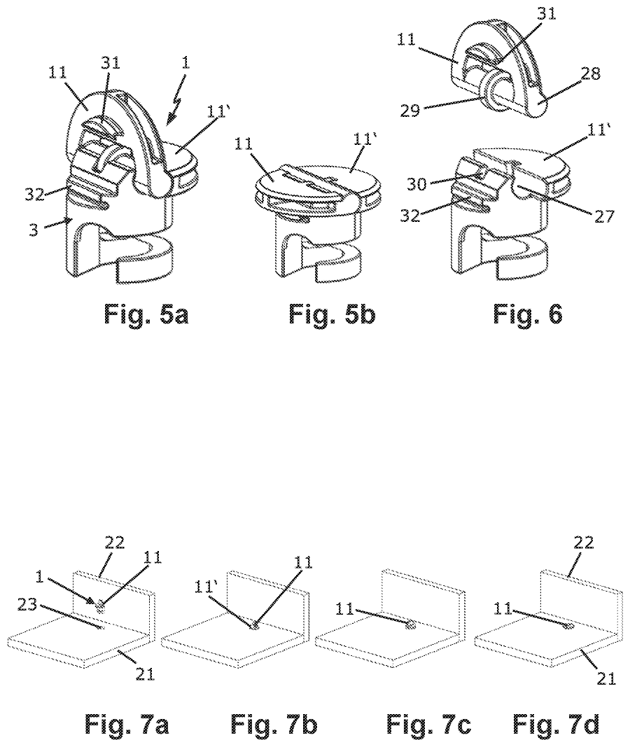

The tightening element 1 shown in FIGS. 5 and 6 differs from the tightening element of FIGS. 1 and 2 as a result of a single (rotary) handle 11 in the form of a semi-circular first cover half which is pivotably supported on a semi-circular second cover half 11′. The second cover half 11′ is formed in a fixed manner on the end side of the housing 3 and protrudes radially outward over the housing 3. In the folded-down end position, the two cover halves 11, 11′ together form a circular cover which protrudes radially outward over the housing 3. The second cover half 11′ has at the end side thereof a semi-cylindrical bearing receiving member 27 in which a cylindrical bearing projection 28 of the handle 11 is locked and rotatably supported. There is formed on the bearing projection 28 an annular collar 29 which engages in a transverse recess 30 of the bearing receiving member 27 in order to thus secure the bearing projection 28 in the bearing receiving member 27 in an axially non-displaceable manner. There is formed on the handle 11 at the lower side a hook 31 which in the folded-down end position engages in a locking manner behind an undercut 32 of the housing 3 in order to thus lock the handle 11 with the housing 3 in the folded-down end position.

FIGS. 7a to 7d show the assembly sequence when two furniture panels 21, 22 which are in abutment with each other at an angle, in this instance at right-angles, are connected using the tightening element 1 shown in FIGS. 5 and 6.

The tightening element 1 is inserted in the surface hole 23 of one first furniture panel 21 with a folded-up handle 11 (FIG. 7a) until the second cover half 11 abuts the first furniture panel 21 (FIG. 7b). Subsequently, the tightening element 1 is rotated in the surface hole 23 using the folded-up handle 11, that is to say, in a tool-free manner, for example, through 240° (FIG. 7c). The clamping bolt 2 is thereby introduced into the circumferential slot 6 and the bolt head 24 behind which the tightening contour 24 engages is now tightened further until the two furniture panels 21, 22 abut each other in a gap-free manner. Finally, the handle 11 is folded down and locked in order to cover the surface hole 23 and the housing 3 (FIG. 7d).

What is claimed is:

1. A tightening element configured for the tool-free tightening of a clamping bolt, comprising:
a cylindrical pot-shaped housing having a pot opening;
wherein at the end side of the housing opposite the pot opening, at least one handle is pivotably supported about an axis which extends at right-angles to the center axis of the housing between a folded-up position which protrudes from the housing and a folded-down end position which rests against the end side.

2. The tightening element as claimed in claim 1, wherein at the end side of the housing opposite the pot opening, two handles are pivotably supported about axes which extend at right-angles to the center axis between a folded-up position which protrudes from the housing and a folded-down end position which rests against the end side.

3. The tightening element as claimed in claim 2, wherein the two handles are each in the form of cover halves which in the folded-down end position together form a cover.

4. The tightening element as claimed in claim 1, wherein the two handles in the folded-down end position protrude radially outward over the housing.

5. The tightening element as claimed in claim 1, wherein at the end side of the housing opposite the pot opening, a single handle in the form of a first cover half is pivotably supported and in that in the folded-down end position the handle and a second cover half which is fixedly formed at the end side of the housing together form a cover.

6. The tightening element as claimed in claim 5, wherein the handle and the second cover half protrude radially outward over the housing.

7. The tightening element as claimed in claim 1, wherein the at least one handle is locked with the housing in the folded-down end position.

8. The tightening element as claimed in claim 7, wherein the at least one handle has a locking projection which in the folded-down end position is engaged in a locking receiving member of the housing, or vice versa.

9. The tightening element as claimed in claim 7, wherein the at least one handle has a hook which in the folded-down end position engages in a locking manner behind an undercut of the housing, or vice versa.

10. The tightening element as claimed in claim 1, wherein the pivot axis is formed by a pin/hole locking connection between the at least one handle and at least one bearing block of the housing.

11. The tightening element as claimed in claim 1, wherein the housing has a circumferential wall having a circumferential slot which extends in a circumferential direction, wherein the inner side of the circumferential wall at both sides of the circumferential slot has a tightening contour which is eccentric relative to the center axis of the housing.

12. The tightening element as claimed in claim 2, wherein the two handles are each in the form of semi-circular cover halves which in the folded-down end position together form a circular cover.

13. The tightening element as claimed in claim 1, wherein at the end side of the housing opposite the pot opening, a single handle in the form of a semi-circular first cover half is pivotably supported and in that in the folded-down end position the handle and a second semi-circular cover half which is fixedly formed at the end side of the housing together form a circular cover.

14. A connection fitting configured for releasably connecting two items of furniture which abut each other at an angle, comprising:
a clamping bolt which is intended to be anchored to one item of furniture; and
the tightening element as claimed in claim 1 which is inserted in a surface hole of the other item of furniture.

15. The connection fitting as claimed in claim 14, wherein the angle is a right-angle.

16. A furniture arrangement, comprising:
the two items of furniture which abut each other at the angle and which are secured to each other by means of the connection fitting as claimed in claim 12;
wherein the clamping bolt is anchored to an end side of the one item of furniture; and
wherein the tightening element is inserted into the surface hole of the other item of furniture and engages behind a bolt head of the clamping bolt.

17. The furniture arrangement as claimed in claim 16, wherein the angle is a right-angle.
